(19) United States
(12) Patent Application Publication
(10) Pub. No.: US 2026/0241903 A1
(43) Pub. Date: Aug. 20, 2026

(54) BRAKE DEVICE FOR RAILWAY VEHICLE

(71) Applicant: Mitsubishi Electric Corporation, Chiyoda-ku, Tokyo (JP)

(72) Inventors: Tetsuya SAEKI, Tokyo (JP); Hidetoshi KITANAKA, Tokyo (JP); Tsutomu NISHIOKA, Tokyo (JP); Etsuji MATSUYAMA, Tokyo (JP)

(73) Assignee: Mitsubishi Electric Corporation, Chiyoda-ku, Tokyo (JP)

(21) Appl. No.: 19/164,457

(22) PCT Filed: Mar. 23, 2023
(86) PCT No.: PCT/JP2023/011432

§ 371 Date: Sep. 11, 2025

(51) Int. Cl. B60T 8/17; B60T 17/22

(52) U.S. Cl. CPC B60T 8/1705; B60T 17/228; B60T 2201/12

(57) ABSTRACT

A brake device for a railway vehicle to generate a braking force by pressing a friction member against a rotator includes a control command acquirer to acquire a proximate-positioning control command for moving the friction member to be proximate to the rotator without generating a decelerating force, a calculator to calculate a minute output target value being a target value of a force for pressing the friction member against the rotator in response to the proximate-positioning control command, a friction member controller to control movement of the friction member based on the minute output target value, and a braking force sensor to detect a braking force generated between the rotator and the friction member. The calculator determines whether the braking force is generated based on detection information from the braking force sensor, and performs correction to decrease the minute output target value when the braking force is generated.

### TECHNICAL FIELD

The present disclosure relates to a brake device for a railway vehicle.

### BACKGROUND ART

A railway vehicle includes a brake system that applies a braking force by pressing a friction member against a wheel or a braking member rotating integrally with the wheel. Such a brake system performs known control for moving the friction member to be proximate to the wheel by applying a specific minute pressure to a brake cylinder when no braking force is generated by the friction member. Such control includes, for example, snow braking and inshot.

Snow braking moves a friction member to be proximate to a wheel by applying a preset minute pressure to a brake cylinder to reduce the likelihood of ice and snow entering between the friction member and the wheel or a braking member rotating integrally with the wheel. Snow braking that reduces the likelihood of ice and snow accumulating between the friction member and the wheel can suppress decrease in the frictional force of the friction member and decrease in the braking force.

To improve the responsivity of a mechanical brake, inshot moves a friction member to be proximate to a wheel or a braking member rotating integrally with the wheel by applying a preset minute pressure to a brake cylinder during regenerative braking. This control can immediately activate the mechanical brake when regenerative braking is ineffective due to, for example, regeneration cancellation.

Patent Literature 1 describes a brake device that generates braking torque by pressing a brake shoe against a wheel or a braking member rotating integrally with the wheel. The brake device in Patent Literature 1 controls driving of a hydraulic pump based on a brake load detected by a load cell during service braking and adjusts the pressing force of the brake shoe to output the braking force as appropriate for each brake notch.

### CITATION LIST

### Patent Literature

Patent Literature 1: Unexamined Japanese Patent Application Publication No. 2001-153164

### SUMMARY OF INVENTION

### Technical Problem

However, Patent Literature 1 does not describe brake control for moving the friction member to be proximate to the wheel or the braking member without generating a decelerating force, unlike snow braking or inshot. Thus, this brake control can cause the friction member to come in contact with the wheel and generate a decelerating force on the railway vehicle depending on the state of the brake device in use such as a brake cylinder or the friction member.

Under such circumstances, an objective of the present disclosure is to provide a brake device for a railway vehicle that can reduce the likelihood of a decelerating force being generated in the railway vehicle.

### Solution to Problem

A brake device for a railway vehicle according to an aspect of the present disclosure is a brake device to generate a braking force by pressing a friction member against a rotator rotating during travel of the railway vehicle. The brake device includes a control command acquirer to acquire a proximate-positioning control command for moving the friction member to be proximate to the rotator without generating a decelerating force, a calculator to calculate a minute output target value being a target value of a force for pressing the friction member against the rotator in response to the proximate-positioning control command acquired by the control command acquirer, a friction member controller to control movement of the friction member based on the minute output target value calculated by the calculator, and a braking force sensor to detect a braking force generated between the rotator and the friction member. The calculator determines whether the braking force is generated based on detection information from the braking force sensor, and performs correction to decrease the minute output target value when the braking force is generated.

### ADVANTAGEOUS EFFECTS OF INVENTION

The brake device for a railway vehicle according to the above aspect of the present disclosure can reduce the likelihood of a decelerating force being generated in the railway vehicle.

### BRIEF DESCRIPTION OF DRAWINGS

FIG. 1 is a diagram of a railway vehicle with an example structure in which a brake device for a railway vehicle according to Embodiment 1 is installed;

FIG. 2 is a diagram of an example processing circuit implemented using a processor and a memory included in the brake device for a railway vehicle according to Embodiment 1;

FIG. 3 is a diagram of an example processing circuit implemented using dedicated hardware included in the brake device for a railway vehicle according to Embodiment 1;

FIG. 4 is a flowchart of an operation of a calculator in the brake device for a railway vehicle according to Embodiment 1;

FIG. 5 is a flowchart of an operation of a calculator in a brake device for a railway vehicle according to Embodiment 2; and

FIG. 6 is a diagram of a railway vehicle with an example structure in which a brake device for a railway vehicle according to Embodiment 3 is installed.

### DESCRIPTION OF EMBODIMENTS

A brake device for a railway vehicle according to one or more embodiments of the present disclosure is described below in detail with reference to the drawings. These embodiments do not limit the present disclosure. In the embodiments described below, the brake device for a railway vehicle may simply be referred to as a brake device. In the embodiments of the present disclosure described below, means for generating a braking force is a wheel tread brake that generates a braking force by pressing a friction member against a wheel using compressed air, but the means is not limited to this example. Other means for generating a braking force include a disc brake that generates a braking force by pressing a friction member against a braking member rotating integrally with the wheel and an electric brake that generates a braking force by operating a friction member using electricity, instead compressed air.

### Embodiment 1

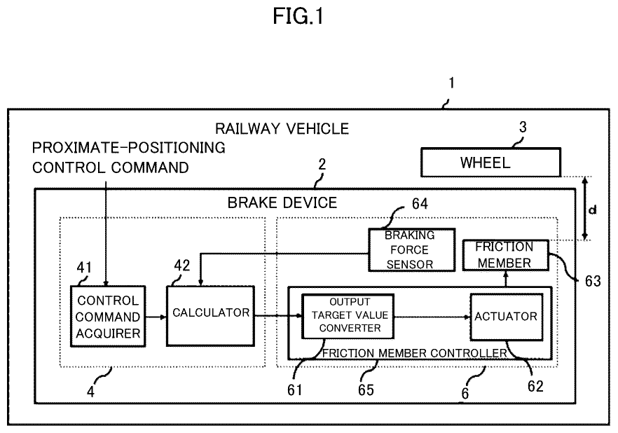

FIG. 1 is a diagram of an example railway vehicle 1 in which a brake device 2 for a railway vehicle according to Embodiment 1 of the present disclosure is installed. The railway vehicle 1 includes the brake device 2 and a wheel 3. The brake device 2 includes a brake controller 4 and a mechanical brake assembly 6. The brake device 2 applies a braking force to the railway vehicle 1 by pressing a friction member 63 included in the mechanical brake assembly 6 against the wheel 3 in the railway vehicle 1. The wheel 3 generates a braking force when pressed with the friction member 63.

The brake controller 4 includes a control command acquirer 41 and a calculator 42.

The control command acquirer 41 acquires a proximate-positioning control command output from a non-illustrated control instructor. The control instructor is, for example, a switch installed in the railway vehicle 1, a master controller installed in a driver cab, a command line such as a wiring circuit breaker, or a train integrated management system. These commands are not limited to signals input from an external control instructor, and may be signals acquired through processing inside the brake controller 4. The proximate-positioning control command is a command for moving the friction member 63 to be proximate to the wheel 3 without generating a decelerating force. Examples of the proximate-positioning control command include a snow braking control command and an inshot control command. Being proximate herein refers to a state of the friction member 63 and the wheel 3 being proximate to each other without any contact or with a degree of contact negligible for a mechanical braking force. The control command acquirer 41 outputs the acquired proximate-positioning control command to the calculator 42.

The calculator 42 calculates a minute output target value that is a target value of a force for pressing the friction member 63 against the wheel 3 in response to the proximate-positioning control command output from the control command acquirer 41. The calculator 42 outputs the minute output target value to a friction member controller 65. In the present embodiment, for example, the calculator 42 calculates a target brake cylinder pressure as the minute output target value in response to the proximate-positioning control command to output the calculated target brake cylinder pressure to the friction member controller 65. The minute output target value may be a set value determined for each proximate-positioning control command. The calculator 42 corrects the minute output target value based on the output from a braking force sensor 64 described below.

The mechanical brake assembly 6 includes the friction member controller 65 including an output target value converter 61 and an actuator 62, the friction member 63, and the braking force sensor 64. The mechanical brake assembly 6 controls the friction member 63 based on the minute output target value output from the calculator 42 in the brake controller 4 to adjust a distance d between the friction member 63 and the wheel 3 and a pressing force applied by the friction member 63 to the wheel 3. The friction member 63 is pressed against the wheel 3 to apply a braking force to the wheel 3. The mechanical brake assembly 6 controls the operation of the friction member 63 with, for example, air pressure, oil pressure, or electricity based on the minute output target value to mechanically apply a braking force to the wheel. The mechanical brake assembly 6 is, for example, a wheel tread brake, a disc brake, or an electric brake.

The friction member controller 65 includes the output target value converter 61 and the actuator 62. The friction member controller 65 controls the movement of the friction member 63 based on the minute output target value output from the calculator 42 in the brake controller 4.

The output target value converter 61 operates the actuator 62 based on the output target value output from the calculator 42 in the brake controller 4. The actuator 62 and the friction member 63 operate in an interrelated manner. The friction member 63 operates in response to the actuator 62.

For a brake using compressed air, for example, the output target value converter 61 in the friction member controller 65 includes a non-illustrated control valve, such as an electropneumatic conversion valve or a relay valve, and a non-illustrated air reservoir. The friction member controller 65 controls the control valve based on the minute output target value output from the calculator 42, or specifically, the target value of the brake cylinder pressure, to output the compressed air in the air reservoir. The actuator 62 such as the brake cylinder thus operates based on the volume of the compressed air. The friction member 63 operates in response to the operation of the actuator 62.

For an electric brake, for example, the output target value converter 61 in the friction member controller 65 includes a non-illustrated electric motor and a non-illustrated electric motor controller that controls the electric motor. The friction member controller 65 controls the electric motor based on the minute output target value output from the calculator 42, or specifically, the target output value for the electric motor, to output power. The actuator 62 that converts the power to a linear motion using, for example, a speed reducer then operates. This operation of the actuator 62 causes the friction member 63 to operate.

The friction member 63 is pressed against the wheel 3 by the actuator 62 in the friction member controller 65 to apply a braking force to the wheel 3. The friction member 63 is, for example, a brake shoe that presses the tread of the wheel 3 or a brake pad that presses a braking member rotating integrally with the wheel 3.

The braking force sensor 64 detects a braking force actually generated between the wheel 3 and the friction member 63, or specifically, detects an actual braking force. The braking force sensor 64 is, for example, a load transducer such as a load cell. The braking force sensor 64 is installed at the friction member 63 and outputs a detection signal to the calculator 42 in the brake controller 4. In the present embodiment, the braking force sensor 64 is installed at the friction member 63, but may be installed at other positions. The braking force sensor 64 may be attached to any component included in the mechanical brake assembly 6 such as the output target value converter 61 or the actuator 62 in the friction member controller 65, or attached to, for example, the wheel 3, an axle that operates with the wheel 3, or a braking member rotating integrally with the wheel 3.

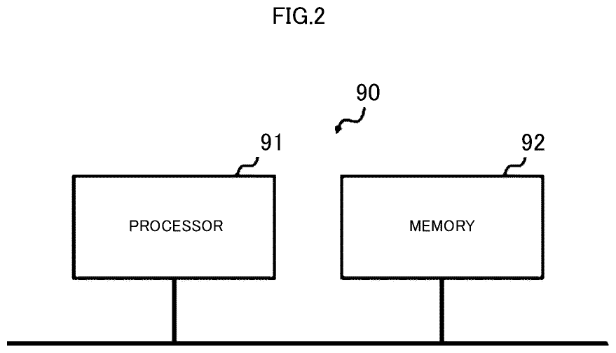

FIG. 2 is a diagram of an example processing circuit 90 implemented using a processor 91 and a memory 92 included in the brake device 2 for a railway vehicle according to Embodiment 1. The processing circuit 90 illustrated in FIG. 2 is a control circuit including the processor 91 and the memory 92. The processing circuit 90 including the processor 91 and the memory 92 has the functions implemented by software, firmware, or a combination of software and firmware. The software and the firmware written as programs are stored in the memory 92. The processing circuit 90 implements the functions when the processor 91 reads and executes the programs stored in the memory 92. More specifically, the processing circuit 90 includes the memory 92 for storing programs that cause the processing of the brake device 2. These programs can cause the brake device 2 to implement the functions of the processing circuit 90. These programs may be provided by a non-transitory storage medium storing the programs or by other means such as a communication medium.

The processor 91 is, for example, a central processing unit (CPU), a processing device, an operation device, a microprocessor, a microcomputer, or a digital signal processor (DSP). The memory 92 is, for example, a nonvolatile or volatile semiconductor memory such as a random-access memory (RAM), a read-only memory (ROM), a flash memory, an erasable programmable ROM (EPROM), or an electrically EPROM (EEPROM, registered trademark), or is, for example, a magnetic disc, a flexible disc, an optical disk, a compact disc, a mini disk, or a digital versatile disc (DVD).

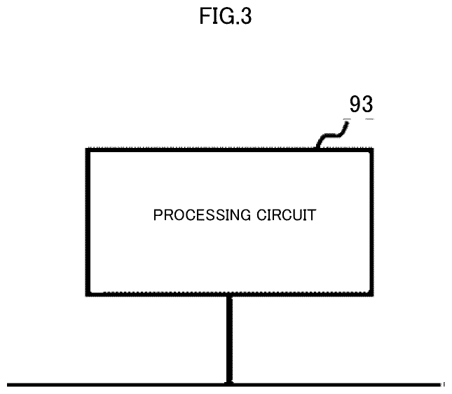

FIG. 3 is a diagram of an example processing circuit 93 implemented using dedicated hardware included in the brake device 2 for a railway vehicle according to Embodiment 1. Examples of the processing circuit 93 illustrated in FIG. 3 include a single circuit, a complex circuit, a programmed processor, a parallel-programmed processor, an application-specific integrated circuit (ASIC), a field-programmable gate array (FPGA), or a combination of two or more of these components. The processing circuit 93 may be partially implemented by dedicated hardware and partially implemented by software or firmware. The processing circuit 93 can thus implement the above functions with dedicated hardware, software, firmware, or a combination of two or more of these components.

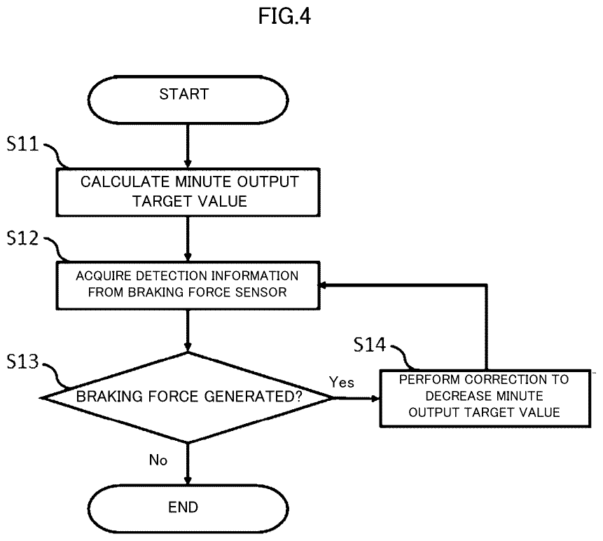

The operation of the brake device 2 for a railway vehicle is now described with reference to flowcharts. FIG. 4 is a flowchart of the operation of the calculator 42 in the brake device 2 for a railway vehicle according to Embodiment 1.

The control command acquirer 41 in the brake controller 4 acquires a proximate-positioning control command for moving the friction member 63 to be proximate to the wheel 3 without generating a decelerating force and outputs the acquired proximate-positioning control command to the calculator 42. The calculator 42 in the brake controller 4 calculates a minute output target value in response to the proximate-positioning control command output from the control command acquirer 41 and outputs the minute output target value to the friction member controller 65 (step S11). The friction member controller 65 controls the friction member 63 to move to a position proximate to the wheel 3 based on the minute output target value. The calculator 42 then acquires detection information from the braking force sensor 64 (step S12). The calculator 42 determines whether a braking force is generated based on the detection information from the braking force sensor 64 (step S13). When the braking force is generated (Yes in step S13), the calculator 42 performs correction to decrease the minute output target value and outputs a control signal indicating the corrected minute output target value to the friction member controller 65 (step S14). The friction member controller 65 thus controls, based on the corrected minute output target value, the friction member 63 to move away from the wheel 3. The calculator 42 again acquires detection information from the braking force sensor 64 (step S12) and determines whether a braking force is generated based on the detection information from the braking force sensor 64 (step S13). When no braking force is generated (No in step S13), the calculator 42 does not correct the minute output target value.

The correction to decrease the minute output target value and the correction to increase the minute output target value as the correction of the minute output target value are taken as decreasing the minute output target value to cause the friction member 63 to move away from the wheel 3 and increasing the minute output target value to cause the friction member 63 to move toward the wheel 3, respectively.

The correction to decrease the minute output target value by the calculator 42 in the brake controller 4 may be subtracting a preset correction amount from the minute output target value or correcting the minute output target value using a correction amount determined based on the detection information from the braking force sensor 64.

As described above, the brake device 2 for a railway vehicle according to the present embodiment moves the friction member 63 to be proximate to the wheel 3 without generating a decelerating force. This control is achieved by the calculator 42 in the brake controller 4 performing correction to decrease the minute output target value when a braking force is generated based on detection information from the braking force sensor 64 that detects a braking force generated between the wheel 3 and the friction member 63. Thus, the brake device 2 can reduce the likelihood of a decelerating force being generated in the railway vehicle 1 during the control for moving the friction member 63 to be proximate to the wheel 3, such as in inshot or snow braking.

The brake device 2 according to one or more embodiments of the present disclosure reduces contact between the friction member 63 and the wheel 3, thus reducing wear of the friction member 63. The brake device 2 also reduces a decelerating force being generated in the railway vehicle 1, thus contributing to energy saving of the entire railway vehicle 1.

### Embodiment 2

In Embodiment 1, the calculator 42 in the brake controller 4 corrects the minute output target value when a braking force is generated between the wheel 3 and the friction member 63. In Embodiment 2 described below, the minute output target value is corrected when no braking force is generated between the wheel 3 and the friction member 63.

In Embodiment 1, the calculator 42 in the brake controller 4 does not correct the minute output target value when no braking force is generated between the wheel 3 and the friction member 63. In the control for moving the friction member 63 to be proximate to the wheel 3, the distance d between the wheel 3 and the friction member 63 is preferably to be minimized. However, when the minute output target value is not corrected with no braking force generated between the wheel 3 and the friction member 63, the friction member 63 may be too far from the wheel 3. In Embodiment 2, when no generation of a braking force is determined based on the detection information from the braking force sensor 64, correction to increase the minute output target value is performed.

The railway vehicle 1 in Embodiment 2 has the same structure as the railway vehicle 1 in Embodiment 1. Explanation of components or structures that are the same as those in Embodiment 1 are omitted as appropriate, and the differences from Embodiment 1 are described.

In Embodiment 2, the calculator 42 in the brake controller 4 has a braking force generation number N that is the number of times the braking force is determined to be generated based on the detection information from the braking force sensor 64. For example, the initial value of the braking force generation number N is zero, and the number is incremented by one every time the braking force is determined to be generated. The initial value and the incremented value may be any values. The braking force generation number N may be substituted by, for example, a flag.

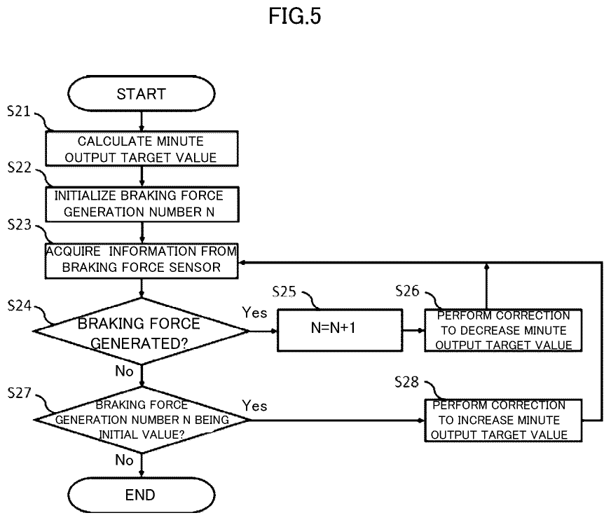

FIG. 5 is a flowchart of the operation of the calculator 42 in the brake device 2 for a railway vehicle according to Embodiment 2.

The control command acquirer 41 in the brake controller 4 acquires a proximate-positioning control command for moving the friction member 63 to be proximate to the wheel 3 without generating a decelerating force and outputs the acquired proximate-positioning control command to the calculator 42. The calculator 42 in the brake controller 4 calculates the minute output target value in response to the proximate-positioning control command received from the control command acquirer 41 and outputs the minute output target value to the friction member controller 65 (step S21).

The friction member controller 65 controls the friction member 63 to move to a position proximate to the wheel 3 based on the minute output target value. Thus, the calculator 42 initializes the braking force generation number N to zero (step S22). The calculator 42 acquires the detection information from the braking force sensor 64 (step S23). The calculator 42 determines whether a braking force is generated based on the detection information from the braking force sensor 64 (step S24).

When a braking force is generated (Yes in step S24), the calculator 42 increments the braking force generation number N by one (step S25), performs correction to decrease the minute output target value, and outputs a control signal indicating the corrected minute output target value to the friction member controller 65 (step S26). Thus, the friction member controller 65 controls, based on the corrected minute output target value, the friction member 63 to move away from the wheel 3. The calculator 42 again acquires the detection information from the braking force sensor 64 (step S23) and determines whether a braking force is generated based on the detection information from the braking force sensor 64 (step S24).

When no braking force is generated (No in step S24), the calculator 42 determines whether the braking force generation number N is an initial value (step S27). When the braking force generation number N is the initial value (Yes in step S27), the calculator 42 performs correction to increase the minute output target value and outputs a control signal indicating the corrected minute output target value to the friction member controller 65 (step S28). Thus, the friction member controller 65 controls, based on the corrected minute output target value, the friction member 63 to move toward the wheel 3. The calculator 42 again acquires the detection information from the braking force sensor 64 (step S23) and determines whether a braking force is generated based on the detection information from the braking force sensor 64 (step S24).

When the calculator 42 determines, based on the detection information from the braking force sensor 64, that no braking force is detected (No in step S24) and the braking force generation number N is not the initial value (No in step S27), the calculator 42 does not correct the minute output target value, because the minute output target value has already been corrected to decrease upon an actual braking force generated at least once to move the friction member 63 to be proximate to the wheel 3.

The calculator 42 in the brake controller 4 may perform the correction to decrease or increase the minute output target value by subtracting or adding a preset correction amount from or to the minute output target value or using a correction amount determined based on the detection information from the braking force sensor 64.

In the present embodiment, the braking force generation number N is initialized once after the proximate-positioning control command output from the control command acquirer 41 is input into the calculator 42, but the braking force generation number N may be initialized in any other manner. During input of the proximate-positioning control command into the calculator 42, the braking force generation number N may be initialized periodically or initialized at any time by, for example, a driver of the railway vehicle.

As described above, the brake device 2 for a railway vehicle according to the present embodiment moves the friction member 63 to be proximate to the wheel 3 without generating a decelerating force. This control is achieved by the calculator 42 in the brake controller 4 performing correction to decrease the minute output target value when a braking force is generated based on the detection information from the braking force sensor 64 that detects a braking force generated between the wheel 3 and the friction member 63 and performing correction to increase the minute output target value when no braking force is generated. Thus, the brake device 2 can reduce the likelihood of a decelerating force being generated in the railway vehicle 1 during the control for moving the friction member 63 to be proximate to the wheel 3, such as during inshot or snow braking. The brake device 2 can also minimize the distance d between the wheel 3 and the friction member 63 when no braking force is generated. The minimized distance d between the wheel 3 and the friction member 63 can reduce the likelihood of ice and snow accumulating between the friction member 63 and the wheel 3, thus suppressing a decrease in the frictional force of the friction member 63 and the mechanical braking force. The brake device 2 can also enhance the responsivity of the mechanical brake to allow prompt activation of the mechanical brake.

### Embodiment 3

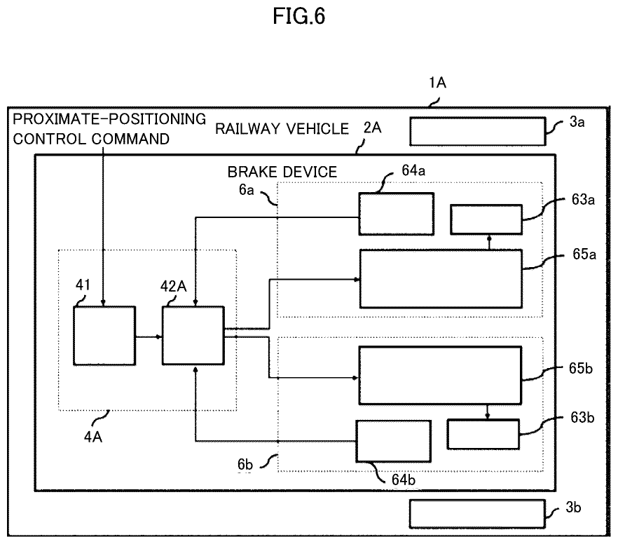

FIG. 6 is a diagram of an example railway vehicle 1A in which a brake device 2A for a railway vehicle according to Embodiment 3 is installed. The components illustrated in FIG. 6 include components having the same or substantially the same functions as the corresponding components of the railway vehicle 1 illustrated in FIG. 1, and such components are denoted by the same reference signs. The components illustrated in FIG. 6 also include sets of multiple components having the same or substantially the same functions as the corresponding component of the railway vehicle 1 illustrated in FIG. 1, and the multiple components in each set are denoted by reference signs each with a lowercase letter for convenience. For example, FIG. 6 illustrates multiple mechanical brake assemblies 6 each illustrated in FIG. 1. The mechanical brake assemblies 6 are labeled as mechanical brake assemblies 6a and 6b. Explanation of components or structures that are the same as those in Embodiments 1 and 2 are omitted as appropriate, and the differences from Embodiments 1 and 2 are described.

In Embodiments 1 and 2, the calculator 42 in the brake controller 4 outputs a single control signal indicating the minute output target value. In Embodiment 3, a calculator 42A in a brake controller 4A outputs multiple control signals indicating minute output target values. In the example described below, the calculator 42A in the brake controller 4A calculates minute output target values for the respective mechanical brake assemblies 6a and 6b.

The control command acquirer 41 in the brake controller 4A acquires a proximate-positioning control command for moving friction members 63a and 63b to be proximate to wheels 3a and 3b without generating a decelerating force. The control command acquirer 41 outputs the acquired proximate-positioning control command to the calculator 42A. The calculator 42A calculates minute output target values for the respective friction members 63a and 63b in the mechanical brake assemblies 6a and 6b in response to the proximate-positioning control command and outputs control signals indicating the minute output target values corresponding to the respective friction members 63a and 63b in the mechanical brake assemblies 6a and 6b. More specifically, the calculator 42A calculates the minute output target value for the friction member 63a and the minute output target value for the friction member 63b in response to the proximate-positioning control command output from the control command acquirer 41, generates control signals indicating the calculated minute output target values, and outputs the control signals to friction member controllers 65a and 65b. These minute output target values may be set values determined by the type of proximate-positioning control command and may be different between a snow braking command and an inshot brake control command.

As in Embodiments 1 and 2, the calculator 42A corrects the minute output target values based on outputs from braking force sensors 64a and 64b. More specifically, the calculator 42A corrects the minute output target value for the friction member 63a based on the braking force sensor 64a and outputs a control signal indicating the corrected minute output target value for the friction member 63a to the friction member controller 65a. The calculator 42A corrects the minute output target value for the friction member 63b based on the braking force sensor 64b and outputs a control signal indicating the corrected minute output target value for the friction member 63b to the friction member controller 65b.

The calculator 42A calculates and corrects the minute output target value for the friction member 63a and the minute output target value for the friction member 63b by identifying each of the minute output target values. For example, the calculator 42A identifies the minute output target values by adding, to the minute output target values, identification information about the output destinations or the output origins of the minute output target values, such as the braking force sensor 64a or 64b or the friction member 63a or 63b, to calculate and correct the minute output target values. The calculator 42A also outputs each minute output target value to the corresponding one of the friction member controllers 65a and 65b by identifying the minute output target value in the same manner. The method of identification is not limited to this example. In FIG. 6, the single calculator 42A calculates and corrects the minute output target values corresponding to the friction members 63a and 63b. However, the brake controller 4A may include multiple calculators 42A to calculate the minute output target values for the friction members 63a and 63b with the respective calculators 42A.

Embodiment 3 differs from Embodiments 1 and 2 in that the minute output target values corresponding to the friction members 63a and 63b are individually calculated and corrected. The calculator 42A in the brake device 2A operates in the same manner as the calculator 42 in the brake device 2 illustrated in FIGS. 4 and 5. Thus, the brake device 2A according to Embodiment 3 can also produce the same effects as the brake device according to Embodiment 1 or 2.

In the example described in Embodiment 3, the friction members 63a and 63b act on different wheels 3a and 3b, but the friction members 63a and 63b may act on the same wheel.

As described above, in the present embodiment, the brake device 2A for a railway vehicle moves the friction members 63a and 63b to be proximate to the wheels 3a and 3b without generating a decelerating force. This control is achieved by the calculator 42A in the brake controller 4A determining whether a braking force is generated based on the detection information from the braking force sensors 64a and 64b that each detect a braking force generated between the wheel 3a or 3b and the corresponding one of the friction members 63a and 63b and correcting the minute output target values corresponding to the friction members 63a and 63b. This can reduce variations in the distance between the friction member 63a and the wheel 3a or between the friction member 63b and the wheel 3b caused by some state of the components in the corresponding one of the mechanical brake assemblies 6a and 6b or some state of the tread of the corresponding one of the wheels 3a and 3b.

The above embodiments merely describe example configuration, and thus, this configuration may be combined with other publicly-known technique, the embodiments of the present disclosure may be combined, and a part of this configuration may be omitted or modified without departing from the gist of the present disclosure.

### REFERENCE SIGNS LIST

1, 1A Railway vehicle
2, 2A Brake device
3, 3a, 3b Wheel
4, 4A Brake controller
41 Control command acquirer
42, 42A Calculator
6, 6a, 6b Mechanical brake assembly
61 Output target value converter
62 Actuator
63, 63a, 63b Friction member
64, 64a, 64b Braking force sensor
65, 65a, 65b Friction member controller
90, 93 Processing circuit
91 Processor
92 Memory

1. A brake device for a railway vehicle to generate a braking force by pressing a friction member against a rotator rotating during travel of the railway vehicle, the brake device comprising:
control command acquiring circuitry to acquire a proximate-positioning control command for moving the friction member to be proximate to the rotator without generating a decelerating force;
calculating circuitry to calculate a minute output target value being a target value of a force for pressing the friction member against the rotator in response to the proximate-positioning control command acquired by the control command acquiring circuitry;
friction member-controller controlling circuitry to control movement of the friction member based on the minute output target value calculated by the calculating circuitry; and
a braking force sensor to detect a braking force generated between the rotator and the friction member,
wherein the calculating circuitry determines whether the braking force is generated based on detection information from the braking force sensor, and performs correction to decrease the minute output target value when the braking force is generated and performs correction to increase the minute output target value when the braking force is not generated.

2. (canceled)

3. The brake device according to claim 1, wherein
the calculating circuitry initializes a braking force generation number being a number of times the braking force is determined to be generated,
the calculating circuitry performs correction to increase the minute output target value when the calculating circuitry determines that the braking force is not generated based on the detection information from the braking force sensor and when the braking force generation number is an initial value, and
the calculating circuitry performs no correction of the minute output target value when the calculating circuitry determines that the braking force is not generated based on the detection information from the braking force sensor and when the braking force generation number is not the initial value.

4-6. (canceled)

7. A brake device for a railway vehicle to generate a braking force by pressing a friction member against a rotator rotating during travel of the railway vehicle, the brake device comprising:
control command acquiring circuitry to acquire a proximate-positioning control command for moving the friction member to be proximate to the rotator without generating a decelerating force;
calculating circuitry to calculate a minute output target value being a target value of a force for pressing the friction member against the rotator in response to the proximate-positioning control command acquired by the control command acquiring circuitry;
friction member controlling circuitry to control movement of the friction member based on the minute output target value calculated by the calculating circuitry; and
a braking force sensor to detect a braking force generated between the rotator and the friction member, wherein
the calculating circuitry determines whether the braking force is generated based on detection information from the braking force sensor, and performs correction to decrease the minute output target value when the braking force is generated,
the calculating circuitry initializes a braking force generation number being a number of times the braking force is determined to be generated,
the calculating circuitry performs correction to increase the minute output target value when the calculating circuitry determines that the braking force is not generated based on the detection information from the braking force sensor and when the braking force generation number is an initial value, and
the calculating circuitry performs no correction of the minute output target value when the calculating circuitry determines that the braking force is not generated based on the detection information from the braking force sensor and when the braking force generation number is not the initial value.

8. A brake device for a railway vehicle, the brake device comprising:
a plurality of mechanical brake assemblies each including the friction member, the friction member controlling circuitry, and the braking force sensor,
wherein each of the plurality of mechanical brake assemblies undergoes the correction according to claim 1.

9. A brake device for a railway vehicle, the brake device comprising:
a plurality of mechanical brake assemblies each including the friction member, the friction member controlling circuitry, and the braking force sensor,
wherein each of the plurality of mechanical brake assemblies undergoes the correction according to claim 3.

10. A brake device for a railway vehicle, the brake device comprising:
a plurality of mechanical brake assemblies each including the friction member, the friction member controlling circuitry, and the braking force sensor,
wherein each of the plurality of mechanical brake assemblies undergoes the correction according to claim 7.

11. The brake device according to claim 1, wherein
the braking force sensor is installed at the friction member, the friction member controlling circuitry, or the rotator.

12. The brake device according to claim 3, wherein
the braking force sensor is installed at the friction member, the friction member controlling circuitry, or the rotator.

13. The brake device according to claim 7, wherein
the braking force sensor is installed at the friction member, the friction member controlling circuitry, or the rotator.

14. The brake device according to claim 8, wherein
the braking force sensor is installed at the friction member, the friction member controlling circuitry, or the rotator.

15. The brake device according to claim 1, wherein
the proximate-positioning control command is an inshot control command or a snow braking control command.

16. The brake device according to claim 3, wherein
the proximate-positioning control command is an inshot control command or a snow braking control command.

17. The brake device according to claim 7, wherein
the proximate-positioning control command is an inshot control command or a snow braking control command.

18. The brake device according to claim 8, wherein
the proximate-positioning control command is an inshot control command or a snow braking control command.

19. The brake device according to claim 11, wherein
the proximate-positioning control command is an inshot control command or a snow braking control command.
